(19) United States
(12) Patent Application Publication
(10) Pub. No.: US 2014/0365436 A1
(43) Pub. Date: Dec. 11, 2014

(54) AUTOMATED SYNCHRONIZATION OF CLIENT-SIDE DATABASE WITH SERVER-SIDE DATABASE OVER A COMMUNICATIONS NETWORK

(71) Applicant: Mobilefast Corporation, Miami, FL (US)

(72) Inventors: Richard Calienes, Miami, FL (US); Jose Garcia Montes, Miami, FL (US); Raciel Porto, Miami, FL (US)

(21) Appl. No.: 13/910,722

(22) Filed: Jun. 5, 2013

(51) Int. Cl. G06F 17/30; H04L 29/08

(52) U.S. Cl. CPC G06F 17/30581; H04L 67/1095
USPC 707/620

(57) ABSTRACT

A computer-readable storage medium including instructions for synchronizing a client-side database on a mobile computing device with a server-side database on a server is disclosed. The computer-readable storage medium includes instructions automatically generating source code configured for synchronizing user selections of the server-side database with the client-side database, and compiling the source code so as to produce executable code for execution on a web server. The computer-readable storage medium further includes instructions for deploying the executable code to the web server and instructions on the web server for executing the executable code on the web server responsive to a request for synchronization with the mobile computing device. The computer-readable storage medium further includes instructions on the server for detecting changes to the database schema of the server-side database and propagating those changes to the client side database.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field of databases and database management and, more specifically, the present invention relates to the field of synchronization of databases.

### BACKGROUND OF THE INVENTION

Various industries, such as those including mobile sales forces, operate a centralized server-side database that interacts with multiple client-side databases operated by employees in the field. As the server-side and client-side databases are modified, the two databases synchronize, so as to ensure that all parties have the same copy of the data in the database.

Most conventional approaches to the aforementioned server-side/client-side database paradigm involve proprietary databases and client programs that operate on a limited number of platforms and operating systems. This limits a consumer's options when choosing a database system to deploy. As the life-cycle of mobile devices, such as smart phones and tablet computers, shortens, however, and the number of commercially available operating systems continues to increase, it becomes increasingly important to deploy client-server programs that can operate on a variety of operating systems, operating environments, database platforms, database formats, and database management systems.

Another one of the drawbacks associated with conventional approaches to the aforementioned server-side/client-side database paradigm involves the constant need to perform complex information technology (IT) tasks that require a vast amount of IT knowledge and man-power. Changing a database schema, for example, often requires the skills of an experienced programmer having to generate an executable program that, when executed, effectuates the appropriate changes to the central server-side database, as well as all of the client-side databases. Deployment of the executable program, however, can be a complex task when hundreds or thousands of client-side databases are involved. This can be tedious, time-consuming and costly for a server-side/client-side database consumer.

Another one of the drawbacks associated with conventional server-side/client-side database paradigms involves the lack of the ability manipulate the client-side data that will be synchronized. Conventionally, all client-side data is synchronized with all server-side data. This all-or-nothing synchronization plan can be inconvenient and unnecessary in situations where only a small of amount of data either on the client-side or the server-side data is usable or relevant. This can further be a disadvantage in situations where it is not desirous that certain sensitive information is shared by a client or by a server.

Therefore, what is needed is a system and method for improving the problems with the prior art, and more particularly for a more efficient and user-friendly way for facilitating the synchronization of a client-side database with a server-side database.

### BRIEF SUMMARY OF THE INVENTION

In one embodiment, the present invention discloses a computer-readable storage medium storing executable instructions, which, when executed, cause a mobile computing device and a server to perform a method for synchronizing a client-side database on the mobile computing device and a server-side database on the server. The computer-readable storage medium includes instructions on the server that provide a graphical user interface that receives selections from a user identifying tables, fields and indexes of the server-side database to be synchronized with the client-side database; instructions on the server for automatically generating tables and stored procedures for keeping track of the selections to be synchronized; instructions on the server for automatically generating source code configured for synchronizing the selections of the server-side database with the client-side database, and compiling the source code so as to produce executable code for execution on a web server; instructions on the server for deploying, over the communications network, the executable code to the web server; instructions on the web server for executing the executable code on the web server responsive to a request for synchronization with the mobile computing device; instructions on the mobile computing device for interacting with the executable code on the web server, so as to create the client-side database to match the server-side database based on a database schema received from the server and so as to synchronize the selections of the server-side database with the client-side database, over the communications network; instructions on the server for detecting changes to the database schema of the server-side database, and responsive to detecting said changes, executing the following instructions: instructions on the server for automatically updating the tables and stored procedures for keeping track of the selections to be synchronized to reflect the new database schema; automatically generating source code for synchronizing the changes to the database schema of the server-side database with the client-side database, and compiling the source code so as to produce updated executable code for execution on the previously specified web server; deploying, over the communications network, the updated executable code to the previously specified web server; instructions on the web server for executing the updated executable code on the web server responsive to a request for synchronization with the mobile computing device; and instructions on the mobile computing device for interacting with the updated executable code on the web server, so as to synchronize the changes to the database schema of the server-side database with the client-side database, over the communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the network architecture of a system for facilitating synchronization of a client-side database with a server-side database over a communications network, in accordance with one embodiment of the present invention.

FIG. 2A is a block diagram showing data flow during the database provisioning process, according to one embodiment of the present invention.

FIG. 2B is a block diagram showing data flow during the database synchronization process, according to one embodiment of the present invention.

FIG. 2C is a block diagram showing data flow during the server command process, according to one embodiment of the present invention.

FIG. 3 is a flow chart depicting the general control flow of a process for facilitating synchronization of a client-side database with a server-side database over a communications network, according to one embodiment of the present invention.

FIG. 4 is a flow chart depicting the control flow of the database provisioning process, according to one embodiment of the present invention.

FIG. 5 is a flow chart depicting the control flow of the database synchronization process, according to one embodiment of the present invention.

FIG. 6 is a flow chart depicting the control flow of the server command process, according to one embodiment of the present invention.

FIG. 7 is an illustration of a graphical user interface that may be used during the database synchronization process, according to one embodiment of the present invention.

FIG. 8 is a block diagram of a system including an example computing device and other computing devices.

### DETAILED DESCRIPTION OF THE INVENTION

The present invention improves upon the problems with the prior art by providing an efficient and user-friendly way for facilitating the synchronization of multiple client-side databases with a server-side database. One of the advantages of the present invention is that it facilitates the synchronization of client databases and server databases having different operating environments and database types. Further, the present invention reduces or eliminates the need for a highly skilled IT worker to perform complex IT tasks, such as generating and compiling source code, when making a database change, such as changing a database schema. Deployment of such changes to the central database can be a seamless task, even when involving a large numbers of client-side databases. An additional benefit of the present invention is the ability for an administrator to manipulate the data that will be synchronized between the client and the server.

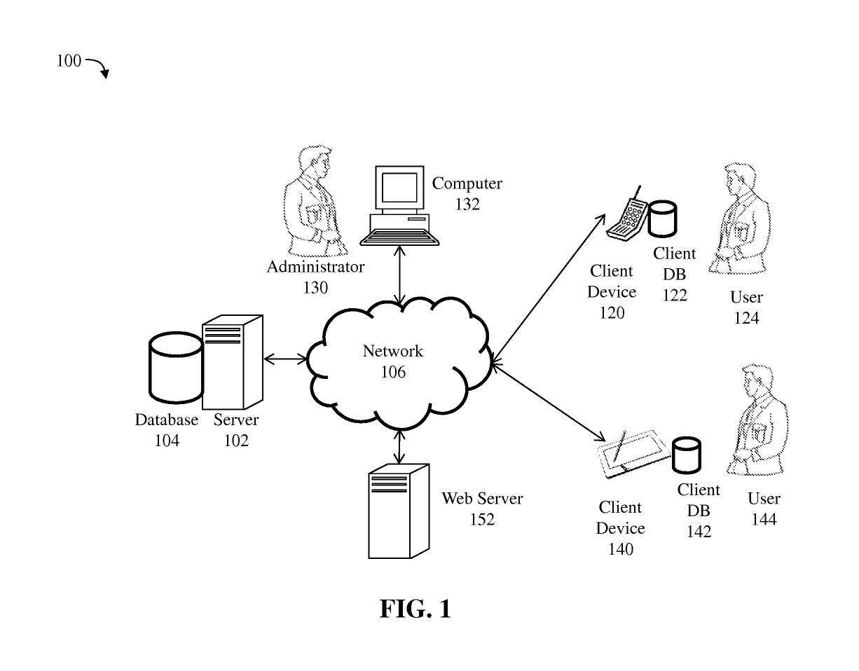

Referring now to the drawing figures in which like reference designators refer to like elements, there is shown in FIG. 1 an illustration of a block diagram showing the network architecture of a system 100 and method for facilitating synchronization of a client-side database with a server-side database over a communications network, in accordance with the principles of the present invention. A prominent element of FIG. 1 is the server 102 associated with a data repository or server-side database 104 and further coupled with network 106, which can be a circuit switched network, such as the Public Service Telephone Network (PSTN), or a packet switched network, such as the Internet or the World Wide Web, the global telephone network, a cellular network, a mobile communications network, a WAN, a LAN, or any combination of the above. Server 102 manages the server-side database 104, which holds the master copy of data that is synchronized to the client-side databases of client computing devices 120, 140.

FIG. 1 further includes client computing devices 120 and 140, which may be mobile computing devices such as smart phones, mobile phones, tablet computers, handheld computers, laptops, or the like. Mobile computing devices 120 and 140 correspond to users 124 and 144, respectively. Computer 132 corresponds to an administrator 130, who may perform supervisory or administrative tasks on server 102. Administrator 130 may, for example, define the data that will be synchronized between the server-side database 104 and the client-side databases 122, 142, define notices that are transmitted to the devices 120, 140, or may define dates and times for synchronization of the server-side database 104 with the client-side databases of client computing devices 120, 140. Computer 132 may be a mobile computing device, a desktop computer, a common computer terminal or the like. Alternatively, administrator 130 may interact directly with server 102.

The server-side database 104 may, for example, be a relational database comprising a Structured Query Language (SQL) database stored in a SQL server. Server-side database 104 may be distributed over one or more nodes or locations that are connected via network 106. Client devices 120 and 140 may also each include their own client-side database 122, 142, respectively. It should be noted that the server 102 may have a different operating system, version number, or operating environment than client devices 120 and 140. Further, the server-side database 104 may have a different database platform, database format, or database management system than the client-side database 122, 142. One of the advantages of the present invention is that it facilitates the synchronization of client databases and server databases having different operating systems, version numbers, operating environments, database platforms, database formats, or database management systems. FIG. 1 further shows a web server 152 connected to network 106, which web server performs the functions of hosting and executing previously compiled executable programs that are used to propagate changes to client side databases.

FIG. 1 shows an embodiment of the present invention wherein networked client computing devices 120 and 140, as well as the administrator computer 132 and server 152, interact with server 102, server 152 and server-side database 104 over the network 106. Servers 102, 152 and client computing devices 120, 140 include a software engine that delivers applications, data, program code and other information to other computing devices via the network 106. It should be noted that although FIG. 1 shows only one server 102, one web server 152 and two client computing devices 120, 140, the system of the present invention supports any number of servers, web server and client computing devices connected via network 106.

Servers 102, 152 and client computing devices 120, 140 include program logic comprising computer source code, scripting language code or interpreted language code that may be compiled to produce an executable file or computer instructions, or that may be interpreted at run-time, wherein the computer source code performs various functions of the present invention.

Note that although server 102 and server 152 are each shown as a single and independent entity, in one embodiment of the present invention, the functions of server 102 and/or web server 152 may be integrated with another entity. Further, servers 102, 152 and their functionality, according to a preferred embodiment of the present invention, can be realized in a centralized fashion in one computer system or in a distributed fashion wherein different elements are spread across several interconnected computer systems.

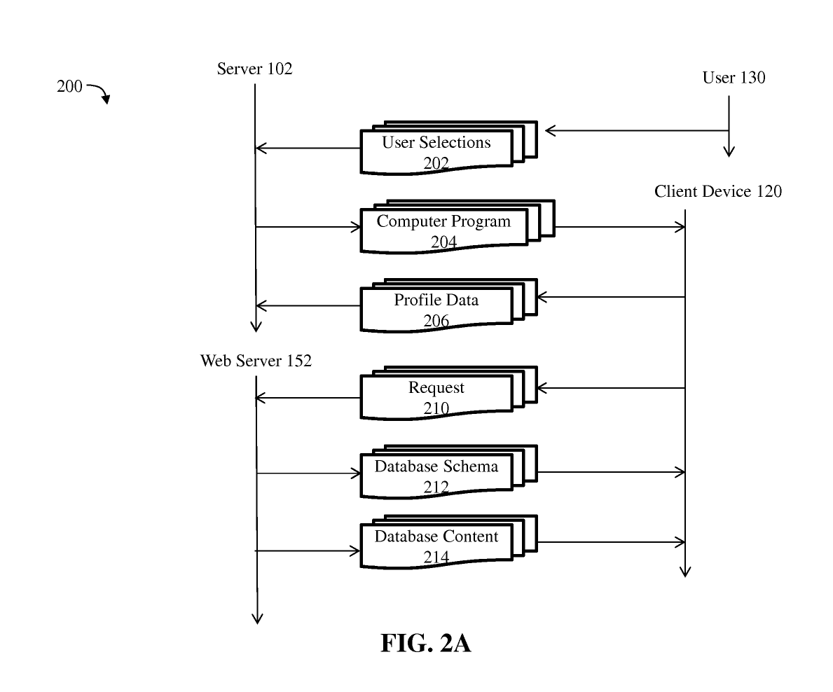

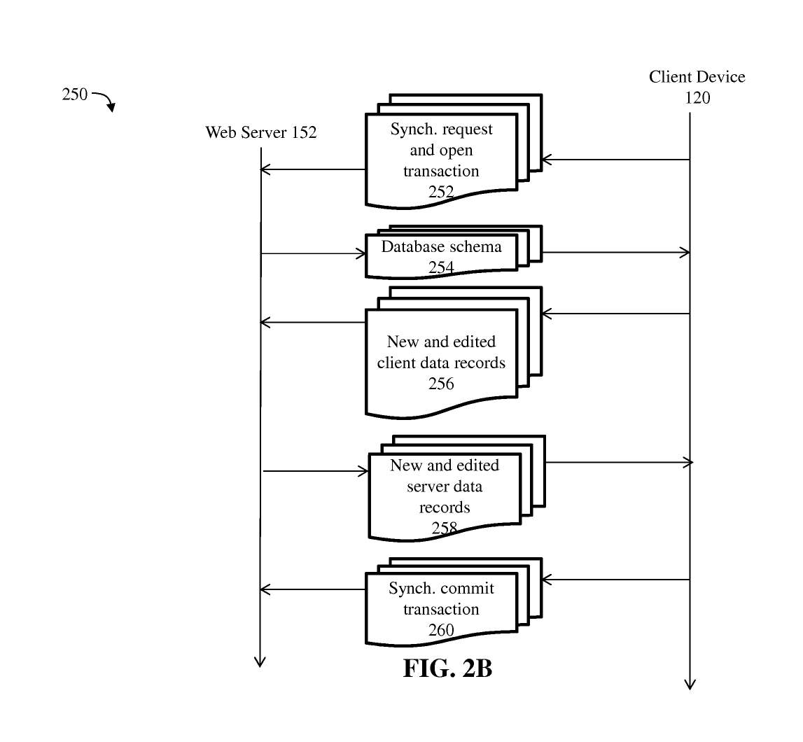

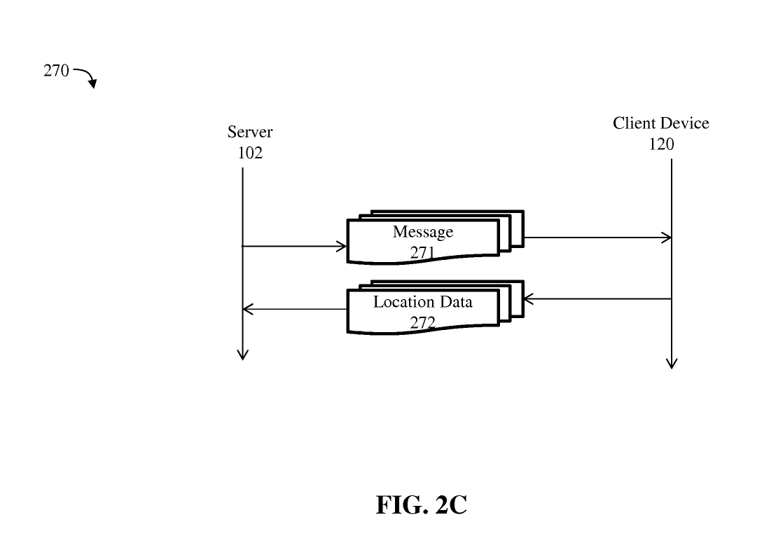

FIG. 2A is a block diagram showing the data flow 200 during the database provisioning process, according to one embodiment of the present invention. The data flow 200 of FIG. 2A shows the flow of data that occurs during the initial provisioning of the client-side database 122 from the server-side database 102.

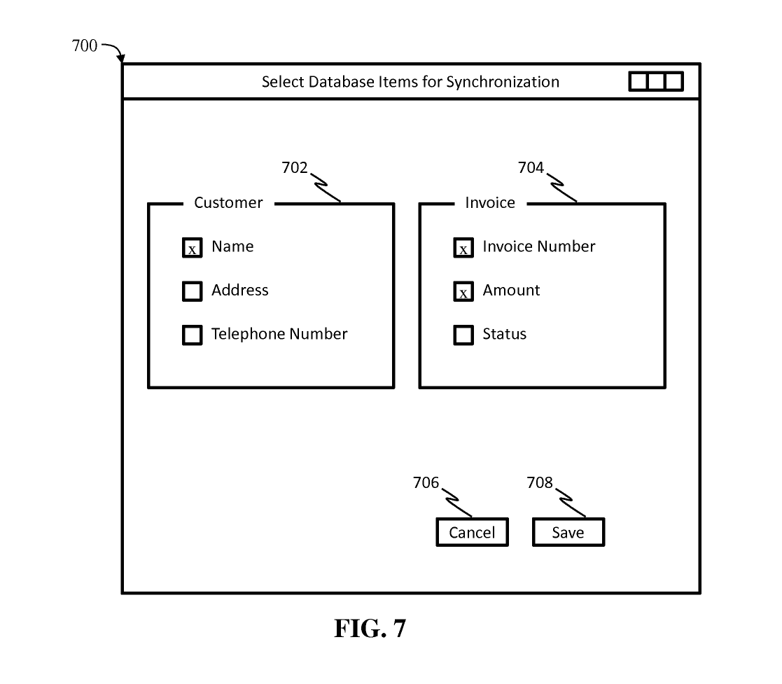

The data flow 200 may begin with the administrator 130 utilizing a graphical user interface (such as the one described below with reference to FIG. 7) to define which database items shall be synchronized between the client-side database 122 and the server-side database 104. Situations may arise where an administrator 130 may not want to synchronize certain client-side database items with the server-side database 104 and vice versa. For example, in a travelling salesman scenario, the user 124 may not want to share his buyer contact information with the server-side database 104 for fear of losing his sales to other salesman. Thus, the administrator 130 may view a graphical user interface that displays the database schema 212 or 254 of the server-side database 104 and allow the administrator 130 to select only those database items that the administrator 130 desires to synchronize between the client-side database 122 and the server-side database 104. Once completed, the administrator's selections 202 may be stored and/or may be transmitted to the server 102. Database items include tables, fields, relationships, views, indexes, packages, procedures, functions, queues, triggers, types, sequences, materialized views, synonyms, database links, directories, etc. of a database.

In another embodiment, the administrator 130 may utilize the graphical user interface 700 of FIG. 7 to define which database tables of the client-side database 122 are upload only and which are download only. A database table that is upload only is uploaded to the server-side database 104 but is never synchronized with the server-side database 104. Therefore, during a synchronization session, the client device 120 does not accept any new data or changes the server 102 makes to an upload only database table. A database table that is download only is downloaded from the server-side database 104 but is never editable by the client device 120. Therefore, during a synchronization session, the server 102 does not accept any changes the client device 120 makes to a download only database table.

Next, client device 120 downloads a computer program 204 from the server 102 or from a third party entity, such as a central computer program server or marketplace, via the network 106. In one example, the client device 120 downloads the computer program 204 from central, public computer program or app marketplace for free or for a small fee. Subsequently, the client device 120 executes the computer program 204. Next, the client device 120 sends profile data 206 to the server 102 via the network 106. Profile data 206 may include information about the platform, operating system, database version, or any other operating environment data about the client-side database 122 or client device 120. Profile data 206 may also include contact information for the user 124, such as name, address, telephone number, email address, etc. Profile data 206 may also include credentials for the user 124, such as user identification, password, encrypted file, login information, encryption key, etc. Any of the profile data 206 may be automatically garnered and read by the computer program 204 or may be entered by the user 124 into his device 120 by manually entering data into a mobile application via keypad, touchpad, or via voice.

In another embodiment, profile data 206 may include data that defines when synchronization sessions will occur. For example, profile data 206 may include a periodic indicator, such as monthly, weekly, or daily, such that synchronization sessions between the server-side database 104 and the client-side database 122 shall occur at the specified periodic intervals. In another example, profile data 206 may include a specific time indicator, such as Mondays at 3 am, such that synchronization sessions between the server-side database 104 and the client-side database 122 shall occur at the specified time each specified interval.

Next, client device 120 sends web server 152 a request 210 to synchronize with the server side database 104. In response, web server 152 transmits to the client device 120 the database schema 212 for the server-side database 104. Database schema defines the structure and organization of data in a database. A database schema 212 may define database items, such as tables, fields, relationships, views, indexes, packages, procedures, functions, queues, triggers, types, sequences, materialized views, synonyms, database links, directories, etc. of the server side database 104.

Once client device 120 has created a client-side database 122 based on the database schema 212, client device 120 may send a request 210 to server 152 for database content 214. In response, the server 152 sends database content 214 of the server-side database 104 to the client device 120 for populating the client-side database 122. This completes the initial provisioning of the client-side database 122.

FIG. 2B is a block diagram showing data flow 250 during the database synchronization process, according to one embodiment of the present invention. The synchronization process in data flow 250 of FIG. 2B begins with the client device 120 sending a request 252 for a synchronization session, as well as the opening of a transaction, to the server 152. This may be spawned as part of a previously planned synchronization session. Request 252 may be in the form of a message and may also include data about the current version of the database schema of the client-side database 122.

Next, the server 152 transmits database schema 254 for the server-side database 104 to the client device 120 via network 106. This step may be spawned by a change that has occurred in the database schema of the server-side database 104 or may be spawned as part of a previously planned synchronization session. In response to receiving the database schema 254, the client device 120 sends to server 152 those client side data records 256 that are either new since, or have been edited since, the last synchronization of the server side database with the client side database.

In response to receiving the client data records 256, the server 152 sends to client 120 those server side data records 258 that are either new since, or have been edited since, the last synchronization of the server side database with the client side database. Consequently, once the all updated database records have been received by both the server 152 and the client device 120, the client device 120 sends a commit synchronization transaction message to the server 152, thereby committing to the synchronization that has just occurred and making permanent said changes to both the server side database with the client side database.

FIG. 2C is a block diagram showing data flow 270 during the server command process, according to one embodiment of the present invention. The server command process in data flow 270 of FIG. 2C begins with the server 102 transmitting a message 271 to the client device 120 via network 106, such as in the form of an email, an SMS message, or the like. In response to this message, the client device 120 may garner location data of the client device 120, such as GPS coordinates, and transmit the location data 272 to the server 102.

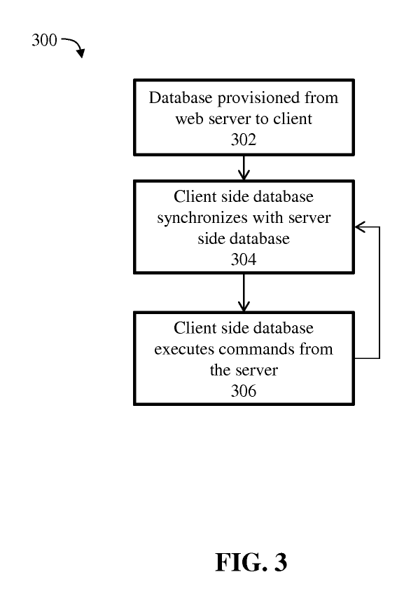

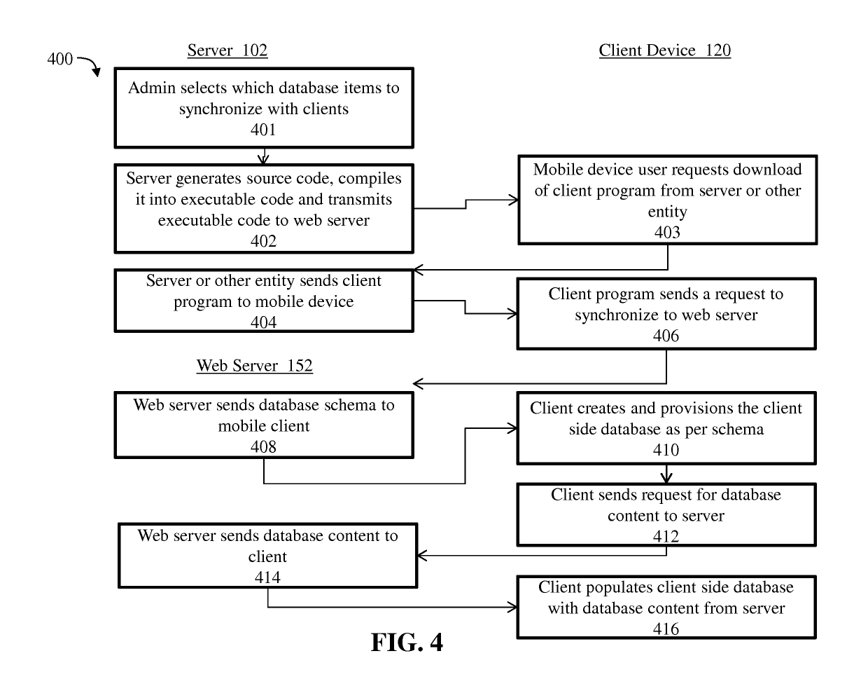

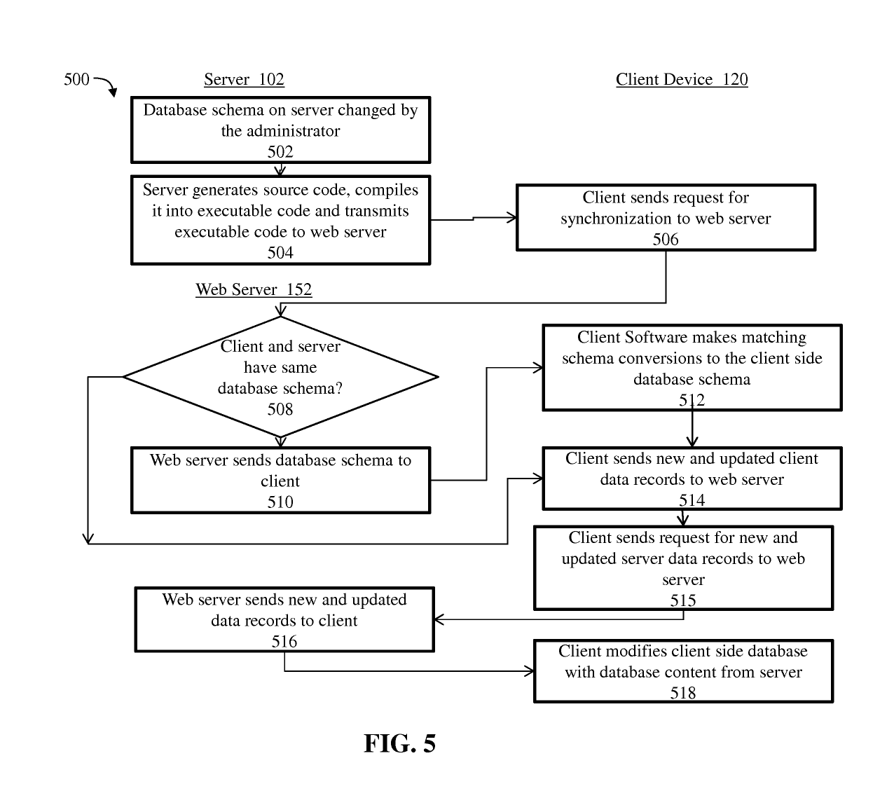

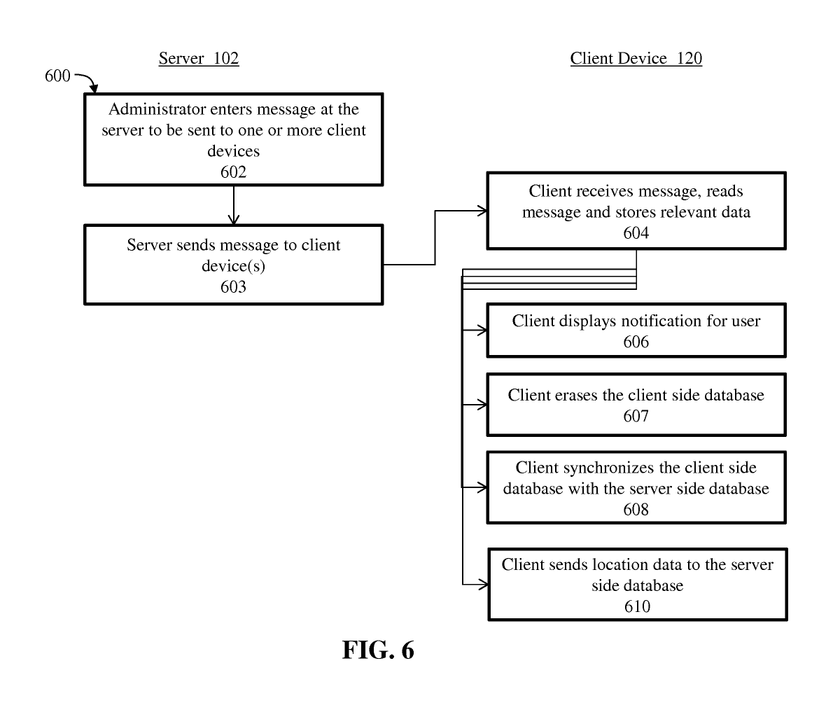

FIG. 3 is a flow chart depicting the general control flow 300 of a process for facilitating synchronization of a client-side database 122 with a server-side database 104 over a communications network 106, according to one embodiment of the present invention. Flow chart 300 generally describes the interactions that occur between the client-side database 122 and the server-side database 104. The flow chart 300 begins with step 302, including the initial provisioning of the client-side database 122 from the server-side database 104, which is described in greater detail below with reference to FIG. 4. Next, in step 304, the client-side database 122 engages in a synchronization session with the server-side database 104, which is described in greater detail below with reference to FIG. 5. Further, in step 306, the client-side database 122 receives, and takes responsive action to, messages from the server 102, which is described in greater detail below with reference to FIG. 6. Subsequently, control flows back to the step 304 wherein steps 304 and 306 are continually repeated.

FIG. 4 is a flow chart depicting the control flow 400 of the database provisioning process, according to one embodiment of the present invention. Flow chart 400 describes the steps that occur during the initial provisioning of the client-side database 122 from the server-side database 104. The flow chart 400 is described with reference to FIG. 2A, which describes the data flow 200 of the aforementioned database provisioning process.

The flow chart 400 may begin with step 401, wherein the administrator 130 utilizes a graphical user interface to define which database items shall be synchronized between the client-side database 122 and the server-side database 104. Next, in step 402, the server 102 automatically generates source code configured for synchronizing the server-side database 104 with the client-side database 122 or initially provisioning the client-side database 122 from the server-side database 104, according to the selections defined in step 401. Subsequently, the server 102 automatically compiles the source code previously generated, wherein the source code is compiled using a compiler and libraries that produce an executable compatible with web server 152. I.e., the executable code that results from the compiling step 402 is configured for execution by server 152, so as to synchronize the server-side database 104 with the client-side database 122 or provision the client-side database 122 from the server-side database 104. Also in step 402, the server 102 automatically transmits, moves or deploys the executable code to the web server 152 via network 106.

In one embodiment, the location or address of web server 152 may be defined by the client device 120 at an earlier time. In another embodiment, the location or address of web server 152 may be defined by administrator 130 at computer 132 or server 102.

In another embodiment, the source code generation of step 402 occurs only in response to receiving a command from a user (such as 130, 124 and/or 144) via a graphical user interface (GUI), such as a push of a GUI button or a series of buttons. In another embodiment, the transmission or deployment of the executable code to the web server 152 via network 106 (also in step 402) also occurs only in response to receiving a command from a user via a GUI.

In step 403, the client device 120 transmits a request for a computer program or app, via network 106, to the server 102 or a third party, such as an online, computer program marketplace. Next, in step 404, the server 102 or third party transmits, and/or the client device 120 downloads, the computer program 204 via the network 106. Subsequently, the client device 120 executes the computer program 204. Next, in step 406, the client device 120 sends to web server 152, via the network 106, a request to synchronize. Also in step 406, the client device 120 may gather profile data 206 and transmit it to the server 102 via the network 106. In one embodiment, the computer program 204 automatically garners some or all of the profile data 206 from the client device 120. In another embodiment, the user 124 enters some or all of the profile data 206 into his device 120 by manually entering data into a mobile application via keypad, touchpad, or via voice.

Subsequently, in step 408, the server 152 transmits database schema 212 for the server-side database 104 to the client device 120, via network 106. In step 410, the client device 120 creates a client-side database 122 based on the database schema 212. Then, in step 412, the client device 120 sends a request to server 152 for database content 214. In response, in step 414, the server 152 sends database content 214 of the server-side database 104 to the client device 120, and in step 416, the client device 120 populates the client-side database 122 with the database content 214. This completes the initial provisioning of the client-side database 122.

FIG. 5 is a flow chart depicting the control flow 500 of the database synchronization process, according to one embodiment of the present invention. Flow chart 500 describes the steps that occur during a typical synchronization session between server-side database 104 and the client-side database 122. The flow chart 500 is described with reference to FIG. 2B, which describes the data flow 250 of the aforementioned database synchronization process.

Flow chart 500 may begin with step 502 wherein the database schema of the server side database 104 is changed or modified, such as by administrator 130. Next, in step 504, the server 102 automatically generates source code configured for modifying the client-side database 122 to reflect the change in database schema. Subsequently, the server 102 automatically compiles the source code previously generated, wherein the source code is compiled using a compiler and libraries that produce an executable compatible with web server 152. Also in step 504, the server 102 automatically transmits, moves or deploys the executable code to the web server 152 via network 106.

In another embodiment, the source code generation of step 504 occurs only in response to receiving a command from a user (such as 130, 124 and/or 144) via a graphical user interface (GUI), such as a push of a GUI button or a series of buttons. In another embodiment, the transmission or deployment of the executable code to the web server 152 via network 106 (also in step 504) also occurs only in response to receiving a command from a user via a GUI.

In step 506, the client device 120 sends a request for a synchronization session to the server 152. Step 506 may be spawned as part of a previously planned synchronization session. For example, the client device 120 may have a previously defined schedule that defines when the client-side database 122 will engage in a synchronization session with the server-side database 104. In step 508, the server 152 determines whether the database schema of the server-side database 104 is the same as the client-side database 122. If the result of the determination of step 508 is positive, then control flows to step 510. If the result of the determination of step 508 is negative, then control flows to step 514.

Step 508 may be accomplished in a variety of ways. In one embodiment, the server 102 and/or server 152 store a current version number identifying the current version of the database schema kept by the server 102 and a current version number identifying the current version of the database schema kept by the device 120. When the device 120 sends a request for a synchronization session to the server 152 in step 506, the server responds with the current version of the server side schema. If the current version of the database schema kept by the device 120 doesn't match the version number of the server 102, then the determination of step 508 is negative—otherwise the determination of step 508 is positive.

In step 510, the server 102 transmits database schema 254 for the server-side database 104 to the client device 120 via network 106. In one alternative embodiment, the transmission of step 510 occurs as a server push that is spawned by a change that has occurred in the database schema of the server-side database 104. I.e., when a change has occurred in the database schema of the server-side database 104, the server 102 detects this change in the database schema of 104 and automatically pushes this change in the database schema to the client device 120 via a message that identifies the changes that have occurred in the database schema.

In step 512, the client device 120 executes instructions that update the database schema of the client-side database according to the database schema received in step 510. This step may involve converting the data format or type of a database item in the client-side database 122 to match the data format or type specified in the database schema received in step 501. For example, a database item may be converted from a whole number to a real number having four decimal places.

In step 514, the client device 120 executes instructions from a computer readable storage medium on the client device 120 to interact with instructions from a computer readable storage medium on the server 152 to synchronize the server-side database 104 with the client-side database 122. In step 514, the client device 120 identifies those database items in client database 122 that satisfy the following criteria: 1) database items of the client-side database 122 that have changed, or are new, or have been deleted since the last synchronization session, and 2) database items of the client-side database 122 that have been selected for synchronization between the server database 104 and the device 120 (in step 401), except for database items of the client-side database 122 that were identified as download only. In step 514, those database items identified above are transmitted to server 152 for synchronization and said database items are updated as such in the server database 104.

Next, in step 515, the client device 120 sends to server 152 a request for new and updated service-side database records. In step 516, the server 152 identifies those database items in server database 104 that satisfy the following criteria: 1) database items of the server database 104 that have changed, or are new, or have been deleted since the last synchronization session, and 2) database items of the server database 104 that have been selected for synchronization between the server database 104 and the device 120 (in step 401), except for those database items of the server database 104 that were identified as upload only. In step 516, server 152 transmits those database items identified above to client device 120 for synchronization and in step 518 said database items are updated as such in the client database 122.

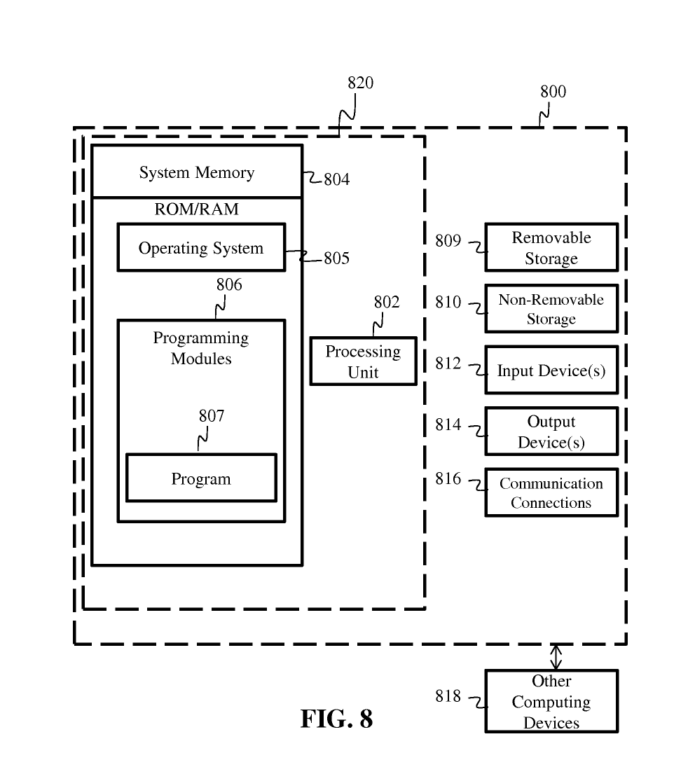

In one embodiment, the instructions from a computer readable storage medium on the device 120 to synchronize the server-side database 104 with the client-side database 122, further includes instructions for detecting a current Wi-Fi communications connection (such as 816—see FIG. 8 below) of the client device 102 to the communications network 106. In the event the instructions detect a WiFi communications connection 816, the instructions enforce the synchronization of steps 506 through 518 of the client-side database 122 with the server-side database 104 to occur only over the Wi-Fi communications connection. This feature takes advantage of the fact that Wi-Fi connections often place no limit, or very high limits, on the amount of data that may be transferred, whereas cellular plans (i.e., data plans for data exchange over a cellular or mobile network) often place limits on the amount of data that may be exchanged and charge higher rates.

FIG. 6 is a flow chart depicting the control flow 600 of the server command process, according to one embodiment of the present invention. Flow chart 600 describes the steps that occur when the client device 120 receives, and takes action in response to, a message 271 from the server 102. The flow chart 600 is described with reference to FIG. 2C, which describes the data flow 270 of the aforementioned server command process.

The flow chart 600 may begin with step 602 wherein an administrator 130 enters a message at the server 102 for transmission to one or more client devices 120, 140. Next, in step 603, the server 102 transmits the message 271 to the devices identified by administrator 130, such as client device 120. The message 271 may be an email message, an SMS message or a message sent using the HTTP protocol. The content of the message 271 may include login credentials, a textual, audio or video notification to the user 124, a command to erase the client side database 122, a command to synchronize the server-side database 104 with the client-side database 122, a synchronization schedule, a request for location data, or the like.

In step 604, the client device 120 receives the message 271, reads the contents of the message and stores the relevant contents of the message. In the event the message 271 includes login credentials, the client device 120 may store the login credentials for use each time the device 120 commences a synchronization session with the server-side database 104. In one embodiment, before the client device 120 stores the login credentials, the client device 120 elicits the user 124 to verify the storage and use of said credential by displaying the credentials to the user 124 in a graphical user interface and eliciting the user 124 to click on a button. In the event the message 271 includes a synchronization schedule, the client device 120 may store the synchronization schedule for use by the device 120 in defining when to initiate a synchronization session with the server-side database 104.

If the message 271 includes a notification to the user 124, in step 606, the device 120 displays or plays the message for the user 124. If the message 271 includes a command to erase the client side database 122, in step 607, the device 120 erases the client side database 122. If the message 271 includes a command to synchronize the server-side database 104 with the client-side database 122, in step 608, the device 120 commences a synchronization session with the server-side database 104, as defined in FIG. 5 above. If the message 271 includes a request for location data, in step 610, the device 120 garners current location data, such as GPS coordinate data, and transmits it to the server-side database 104.

FIG. 7 is an illustration of a graphical user interface 700 that may be used during the database provisioning process of FIG. 4, according to one embodiment of the present invention. Graphical user interface 700 may be used during the execution of step 401 of the database provisioning process above. Recall that in certain situations, administrator 130 may not desire to synchronize certain items with the client-side database 122. In these cases, the administrator 130 may view the graphical user interface 700 that displays some or all of the database schema 212 or 254 of the server-side database 104 and allows the administrator 130 to select only those database items to be synchronized with the client-side database 122.

Interface 700 displays two areas, wherein the first area 702 displays database items that pertain to a customer record and wherein the second area 704 displays database items that pertain to an invoice record. Interface 700 shows that the administrator 130 may select certain database items in each area by selecting or de-selecting radio buttons. Interface 700 shows that the administrator 130 has opted to synchronize only the name of each of the customers in the server-side database 104, because it may not be desirous to share the address and telephone number of customers with client users, such as user 124. Interface 700 also shows that the administrator 130 has opted to synchronize only the invoice number and amount of the invoices in server-side database 104. Once the administrator 130 has completed selecting or de-selecting database items in interface 700, the administrator 130 may either save his selections by clicking on the “save” button 708 or erasing his selections by clicking on the “cancel” button 706.

FIG. 8 is a block diagram of a system including an example computing device 800 and other computing devices. Consistent with the embodiments described herein, the aforementioned actions performed by computers 102, 132, 152, 120 and 140 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device. Furthermore, computing device 800 may comprise an operating environment for all or a portion of the processes, methods, control flows and data flows shown in FIGS. 2A-6 above.

With reference to FIG. 8, a system consistent with an embodiment of the invention may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), nonvolatile (e.g. read-only memory (ROM)), flash memory, or any combination or memory. System memory 804 may include operating system 805, one or more programming modules 806 (such as program module 807). Operating system 805, for example, may be suitable for controlling computing device 800's operation. In one embodiment, programming modules 806 may include, for example, a program module 807. Furthermore, embodiments of the invention may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a camera, a touch input device, etc. Output device(s) 814 such as a display, speakers, a printer, etc. may also be included. The aforementioned devices are only examples, and other devices may be added or substituted.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules 806 and data files may be stored in system memory 804, including operating system 805. While executing on processing unit 802, programming modules 806 may perform processes including, for example, all or a portion of the processes, methods, control flows and data flows shown in FIGS. 2A-6 above. The aforementioned processes are examples, and processing unit 802 may perform other processes. Other programming modules that may be used in accordance with embodiments of the present invention may include electronic mail and contacts applications, word processing applications, spreadsheet applications, messaging applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable storage medium storing executable instructions, which, when executed, cause a mobile computing device and a server to perform a method for synchronizing a client-side database on the mobile computing device and a server-side database on the server, the computer-readable storage medium comprising:
instructions on the server that provide a graphical user interface that receives selections from a user identifying tables, fields and indexes of the server-side database to be synchronized with the client-side database;
instructions on the server for automatically generating tables and stored procedures for keeping track of the selections to be synchronized;
instructions on the server for automatically generating source code configured for synchronizing the selections of the server-side database with the client-side database, and compiling the source code so as to produce executable code for execution on a web server;
instructions on the server for deploying, over the communications network, the executable code to the web server;
instructions on the web server for executing the executable code on the web server responsive to a request for synchronization with the mobile computing device;
instructions on the mobile computing device for interacting with the executable code on the web server, so as to create the client-side database to match the server-side database based on a database schema received from the server and so as to synchronize the selections of the server-side database with the client-side database, over the communications network;
instructions on the server for detecting changes to the database schema of the server-side database, and responsive to detecting said changes, executing the following instructions:
instructions on the server for automatically updating the tables and stored procedures for keeping track of the selections to be synchronized to reflect the new database schema;
automatically generating source code for synchronizing the changes to the database schema of the server-side database with the client-side database, and compiling the source code so as to produce updated executable code for execution on the previously specified web server;
deploying, over the communications network, the updated executable code to the previously specified web server;
instructions on the web server for executing the updated executable code on the web server responsive to a request for synchronization with the mobile computing device; and
instructions on the mobile computing device for interacting with the updated executable code on the web server, so as to synchronize the changes to the database schema of the server-side database with the client-side database, over the communications network.

2. The computer-readable storage medium of claim 1, further comprising instructions on the mobile computing device for encrypting the client-side database using a previously provided encryption key and password.

3. The computer-readable storage medium of claim 2, wherein the instructions on the mobile computing device for interacting with the executable code on the web server, further includes instructions for detecting a current Wi-Fi communications connection of the mobile computing device to the communications network and enforcing the synchronization of the client-side database with the server-side database to take place over the Wi-Fi communications connection.

4. The computer-readable storage medium of claim 3, further comprising instructions on the server for sending notifications to the mobile computing device over the communications network, wherein the notifications are configured for display on the mobile computing device upon synchronization of the client-side database with the server-side database.

5. The computer-readable storage medium of claim 4, further comprising instructions on the mobile computing device for receiving, via the communications network, an encrypted SMS message or an email message containing a command to erase the client-side database and, responsive to detecting said SMS message or email message, erasing the client-side database.

6. The computer-readable storage medium of claim 5, further comprising instructions on the mobile computing device for receiving, via the communications network, an encrypted SMS message or an email message containing a command to synchronize the client-side database with the server-side database and, responsive to detecting said SMS message or email message, executing said instructions on the mobile computing device for interacting with executable code on the web server, so as to synchronize the server-side database with the client-side database, over the communications network.

7. The computer-readable storage medium of claim 6, further comprising instructions on the mobile computing device for receiving, via the communications network, an encrypted SMS message or an encrypted email message containing login credentials for the server-side database, displaying a graphical user interface for eliciting a validation of the login credentials from a client user and, responsive to receiving said validation, storing the login credentials; and instructions on the mobile computing device for using said login credentials to log into the server-side database upon execution of said instructions on the mobile computing device for interacting with executable code on the web server, so as to synchronize the server-side database with the client-side database, over the communications network.

8. A computer-readable storage medium storing executable instructions, which, when executed, cause a mobile computing device and a server to perform a method for synchronizing a client-side database on the mobile computing device and a server-side database on the server, the computer-readable storage medium comprising:
instructions on the server that provide a graphical user interface that receives selections from a user identifying tables, fields and indexes of the server-side database to be synchronized with the client-side database;
instructions on the server for automatically creating the tables and stored procedures for keeping track of the selections to be synchronized;
instructions on the server for automatically generating source code configured for synchronizing the selections of the server-side database with the client-side database, and compiling the source code so as to produce executable code for execution on a previously specified web server, responsive to receiving, via a graphical user interface, a command from the user instructing generation of the source code;
instructions on the server for deploying, over the communications network, the executable code to the web server;
instructions on the web server for executing the executable code on the web server responsive to a request for synchronization with the mobile computing device;
instructions on the mobile computing device for interacting with the executable code on the web server, so as to create the client-side database to match the server-side database based on a database schema received from the server and so as to synchronize the selections of the server-side database with the client-side database, over the communications network;
instructions on the server for detecting changes to the database schema of the server-side database, and responsive detecting said changes, executing the following instructions:
instructions on the server for automatically updating the tracking tables and stored procedures for keeping track of the selections to be synchronized to reflect the new database schema;
automatically generating source code for synchronizing the changes to the database schema of the server-side database with the client-side database, and compiling the source code so as to produce updated executable code for execution on the previously specified web server;
deploying, over the communications network, the updated executable code to the previously specified web server;
instructions on the web server for executing the updated executable code on the web server responsive to a request for synchronization with the mobile computing device; and
instructions on the mobile computing device for interacting with the updated executable code on the web server, so as to synchronize the changes to the database schema of the server-side database with the client-side database, over the communications network.

9. The computer-readable storage medium of claim 8, further comprising instructions on the mobile computing device for encrypting the client-side database using a previously provided encryption key and password.

10. The computer-readable storage medium of claim 9, wherein the instructions on the mobile computing device for interacting with the executable code on the web server, further includes instructions for detecting a current Wi-Fi communications connection of the mobile computing device to the communications network and enforcing the synchronization of the client-side database with the server-side database over the Wi-Fi communications connection.

11. The computer-readable storage medium of claim 10, further comprising instructions on the server for sending notifications to the mobile computing device over the communications network, wherein the notifications are configured for display on the mobile computing device upon synchronization of the client-side database with the server-side database.

12. The computer-readable storage medium of claim 11, further comprising instructions on the mobile computing device for receiving, via the communications network, an encrypted SMS message or an email message containing a command to erase the client-side database and, responsive to detecting said SMS message or email message, erasing the client-side database.

13. The computer-readable storage medium of claim 12, further comprising instructions on the mobile computing device for receiving, via the communications network, an encrypted message containing a synchronization schedule and, responsive to receiving said message, executing each subsequent synchronization of the client-side database with the server-side database according to said synchronization schedule.

14. The computer-readable storage medium of claim 13, further comprising instructions on the mobile computing device for reading location information pertaining to a geographic location of the mobile computing device and transmitting the location information to the server via the communications network.

15. A computer-readable storage medium storing executable instructions, which, when executed, cause a mobile computing device and a server to perform a method for synchronizing a client-side database on the mobile computing device and a server-side database on the server, the computer-readable storage medium comprising:
instructions on the server that provide a graphical user interface that receives selections from a user identifying tables, fields and indexes of the server-side database to be synchronized with the client-side database;
instructions on the server for automatically creating the tracking tables and stored procedures for keeping track of the selections to be synchronized;
instructions on the server for automatically generating source code configured for synchronizing the selections of the server-side database with the client-side database, and compiling the source code so as to produce executable code for execution on a previously specified web server, responsive to receiving, via a graphical user interface, a command from the user instructing generation of the source code;
instructions on the server for deploying, over the communications network, the executable code to the web server, responsive to receiving, via a graphical user interface, a command from the user instructing deployment of the executable code to the web server;
instructions on the web server for executing the executable code on the web server responsive to a request for synchronization with the mobile computing device;
instructions on the mobile computing device for interacting with the executable code on the web server, so as to create the client-side database to match the server-side database based on a database schema received from the server and so as to synchronize the selections of the server-side database with the client-side database, over the communications network;
instructions on the server for detecting changes to the database schema of the server-side database, and responsive detecting said changes, executing the following steps:
instructions on the server for automatically updating the tables and stored procedures for keeping track of the selections to be synchronized to reflect the new database schema;
automatically generating source code for synchronizing the changes to the database schema of the server-side database with the client-side database, and compiling the source code so as to produce updated executable code for execution on the previously specified web server;
deploying, over the communications network, the updated executable code to the previously specified web server;
instructions on the web server for executing the updated executable code on the web server responsive to a request for synchronization with the mobile computing device; and
instructions on the mobile computing device for interacting with the updated executable code on the web server, so as to synchronize the changes to the database schema of the server-side database with the client-side database, over the communications network.

16. The computer-readable storage medium of claim 15, further comprising instructions on the mobile computing device for encrypting the client-side database using a previously provided encryption key and password.

17. The computer-readable storage medium of claim 16, wherein the instructions on the mobile computing device for interacting with the executable code on the web server, further includes instructions for detecting a current Wi-Fi communications connection of the mobile computing device to the communications network and enforcing the synchronization of the client-side database with the server-side database over the Wi-Fi communications connection.

18. The computer-readable storage medium of claim 17, further comprising instructions on the server for sending notifications to the mobile computing device over the communications network, wherein the notifications are configured for display on the mobile computing device upon synchronization of the client-side database with the server-side database.

19. The computer-readable storage medium of claim 18, further comprising instructions on the mobile computing device for receiving, via the communications network, an encrypted SMS message or an email message containing a command to erase the client-side database and, responsive to detecting said SMS message or email message, erasing the client-side database.

20. The computer-readable storage medium of claim 19, further comprising instructions on the server for creating and maintaining a list of authorized client users; and instructions on the server for authenticating a client user of the mobile computing device against the list, responsive to receiving a request for synchronization from the mobile computing device.
